(19) United States
(12) Patent Application Publication
(10) Pub. No.: US 2004/0194363 A1
(43) Pub. Date: Oct. 7, 2004

(54) Changeable golf sponsor display

(76) Inventors: Terry Lee Wagenknecht, Rockford, IL (US); Samuel James Wagenknecht, Rockford, IL (US); Charles Maxwell Wagenknecht, Rockford, IL (US)

Correspondence Address: Terry Lee Wagenknecht, 6693 Heather Lane, Rockford, IL, 61114, US

(21) Appl. No.: 10/812,332

(22) Filed: Mar. 29, 2004

Related U.S. Application Data
(60) Provisional application No. 60/459,004, filed on Apr. 1, 2003.

(51) Int. Cl. G09F 3/04

(52) U.S. Cl. 40/642.02; 40/611.13; 40/611.06

(57) ABSTRACT

A cylindrically curved self supporting changeable indicia substrate retaining display for securing and displaying a variety of printed indicia substrates; more particularly, as a changeable golf sponsor display; comprising an indicia substrate retaining appendage formed by a completely through cut, and tear preventive, indicia substrate retaining slit in a single flexible display substrate. Said indicia substrate is secured by surrounding and retained curvature stresses when subjected to directionally predetermined compression; with all tensions retained by a ground penetrating fixed width wire rod leg set that is vertically invertable and or retractable for use as an indoor self supporting display.

CROSS-REFERENCE TO RELATED APPLICATIONS

| | | | |
|---|---|---|---|
| 4,270,292 | February 1981 | Eckberg,Il | 40/611 |
| 5,408,774 | April 1995 | Grewe et al | 40/606 |
| 5,448,844 | September 1995 | Miller, Jr. et al | 40/611 |
| 5,619,816 | April 1997 | Ellison | 40/738 |
| 5,675,923 | October 1997 | Sarkisian et al | 40/612 |
| 5,678,339 | October 1997 | Marventano | 40/789 |
| 6,253,478 B1 | July 2001 | Kalavity | 40/645 |
| 6,276,084 B1 | August 2001 | Lanier | 40/611 |
| 6,449,891 B1 | September 2002 | Miska | 40/789 |
| 6,584,717 B2 | July 2003 | Cinquina | 40/774 |
| 6,594,934 B1 | July 2003 | Wong | 40/743 |

### STATEMENT REGARDING FEDERALLY SPONSORED RESEARCH OR DEVELOPMENT

Not applicable.

### REFERENCE TO SEQUENCE LISTING

Not applicable.

### BACKGROUND OF THE INVENTION

### Category Field of the Invention

The present invention relates to changeable indicia substrate displays, more particularly to changeable golf sponsor displays suited for penetrating the ground, but not exclusively; as said invention is self supporting for indoor counter top or floor display use and also changeable to outdoor use, including ground penetration.

### BACKGROUND OF THE INVENTION

### Description of Prior Art

Charitable golf outings display sponsor and donor names, using sponsor signs that are placed in the ground throughout the golf course. The current method of supply, is computer cut vinyl lettering applied to a corrugated substrate, and supported by low quality, and quick to rust “H-shaped” wire stands. When golfing during the event, these said current displays become moving distractions in the slightest wind. Said current sign display is both expensive to have lettered, and also expensive to remove and re-letter any new sponsor names or tournament information. The tournament director is totally dependent on a local sign shop for price, quality, and rush deadline sponsor additions. Transporting and storage of this corrugated sign and wire stand sign are both cumbersome and bulky. The use of said current display is limited to the golf course on tournament day only, with no other options of use.

### SUMMARY

This invention of a changeable golf sponsor display is purposed to free up the user's dependency on others to supply printed sponsor indicia, provide more options in substrate types used, including how, when and where said display can be used. The full extension of a retractable, stainless steel leg set transforms a single flexible planar display substrate into a 3-D appearing curvature shape. An optional and vertically adjustable sliding clip allows various size and thickness of rigid indicia substrates to be quickly mounted to frontward convex surface of said display. The instant speed of changing said indicia substrates competes with all other assets, including compact storage, safe and easy handling, and vertical self-standing stability.

With leg set retracted and inverted, said leg set retains said curvature shape for optional pre-tournament advertising use as an indoor counter top or floor display within a sponsor's own business location, or by any others affiliated with the golf event. A pre-event display advertises the golf tournament for attendance and sponsorship; whereas said display changes to an outdoor ground penetrating display during the event; and then changes back to an indoor display, thanking those previously solicited, with photos and dollar amounts taken in. These opened-up options of how, when and where said display is used, all fill a need in any tournament director's end goal. Last minute sponsor changes, or any message needed quickly, may be printed from any computer and instantly displayed. One multi-purpose display can now be used before, during and after the golf event.

User's dependency on others is freed up, with many more options left open.

### BRIEF DESCRIPTION OF THE DRAWINGS

FIG. 1 shows rear view of preferred embodiment with leg set extended, cylindrically curved shape retained, indicia retaining slit with predetermined vector line beginning and ending stress points, and a plurality of apertures and notches.

FIG. 2 shows an overhead view with leg set extended.

FIG. 3 shows rear view before forming said leg set apertures.

FIG. 4 shows rear view in storage form, with said leg set retracted, and one leg of said leg set removed from leg set retaining apertures.

FIG. 5 shows rear view with said leg set inverted, for use as a self standing display.

FIG. 6 shows front view with uppermost vertical planar edge pulled back for flexible indicia insertion.

FIG. 7 shows front view with leg set deployed, and rigid indicia substrate inserted.

FIG. 8,a and FIG. 8,b show front and back views respectively, of vertically adjustable sliding clip. FIG. 8,c shows substrate shape before forming.

### NUMERALS IN DRAWINGS

10 main body of display substrate

12 ground level

14 wire rod leg set

16 elongate bent leg tips

18 leg set retaining aperture

20 lower base curvature of display

22 vector line slit stressed end points

24 completely cut-through slit

26 rigid indicia retaining tab

28 indicia retaining appendage

30 planar edge perimeter notch

32 horizontal display width comparison

34 main body curvature

36 aperture forming support tabs

38 aperture area before forming

40 flexible indicia substrate

42 rigid indicia substrate

44 uppermost vertical planar edge

46 vertically adjustable sliding clip

48 curved tab of sliding clip

### DETAILED DESCRIPTION OF THE INVENTION

Fabrication of the overall perimeter edge shape or design is optionally altered to most any single shape that suits the event; from a golf ball and tee shape, to a soccer or football, without detracting from the function or scope of the invention. Said option of changing said perimeter shape of said display is possible through the simplicity of the tear preventive indicia retaining slit which forms the indicia substrate retaining appendage. Fabrication of perimeter design shape and functional indicia substrate retention area is done with one downstroke of a die-cutter; and by using only one piece of flexible planar substrate material, plus a means of retention source. A means of retention may include exteriorly fixed abutments, a fixed length tie strap, a resilient stretchable bungee cord, or a fixed width wire rod leg set. This particular display is made of two main parts; a flexible planar polymer substrate, and a said fixed wire rod leg set. A third and optional part is a vertically adjustable sliding clip; made also from the same type of substrate as said display, and purposed to retain rigid indicia substrates.

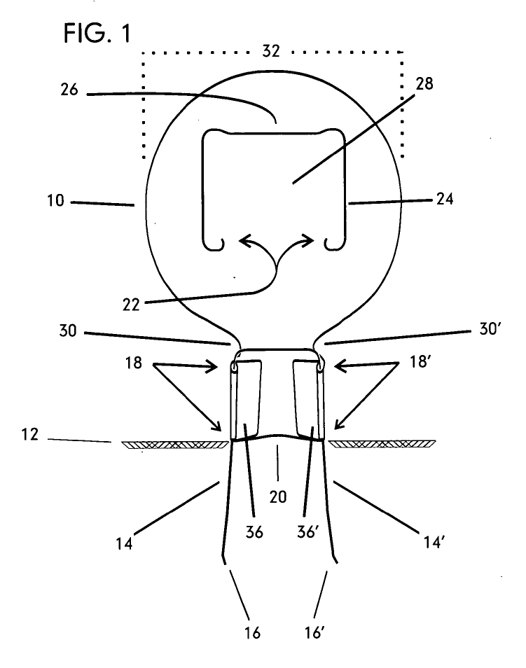

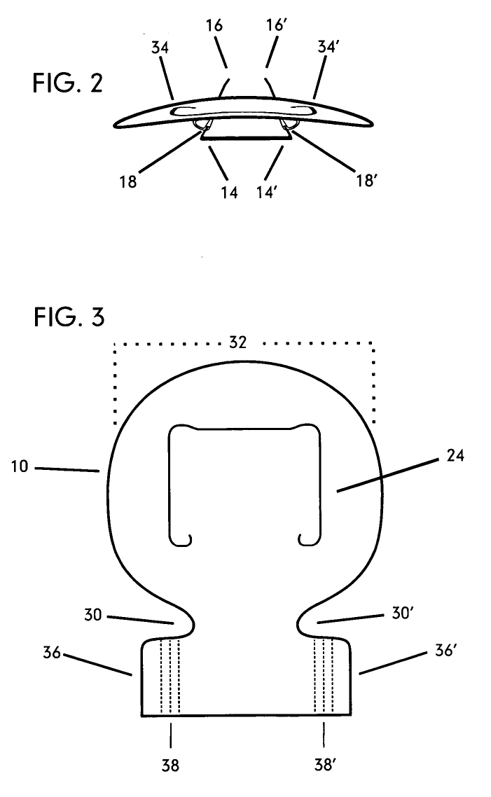

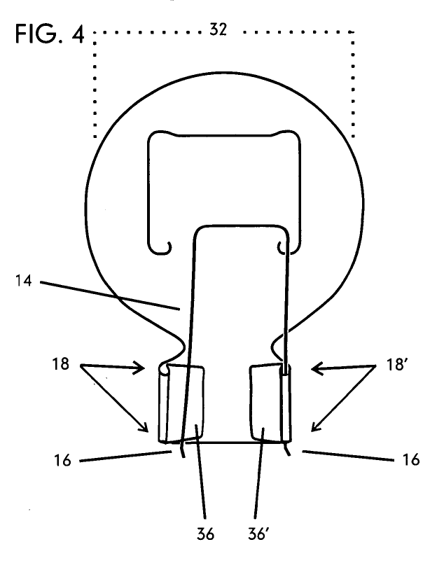

The major components comprising; a formed shape of the main body FIG. 3,10 of a flexible planar substrate; a completely cut through slit FIG. 3,24, to be referred to as a flexible indicia substrate retaining slit, or retaining slit; A plurality of determinedly spaced planar edge perimeter notches FIG. 3,30; a plurality of aperture forming support tabs FIG. 3,36, to be referred to as support tabs; and the areas FIG. 3,38, to be formed into a plurality of determinedly spaced apertures FIG. 2,18, to be referred to as leg set apertures. Also shown in FIG. 3,32 are dotted lines to show future width and horizontal compression of said display (when compared with FIG. 1 and FIG. 4).

Fabrication of said leg set apertures (FIG. 1,18) are formed in said areas FIG. 3,38, (using methods relating to and accordingly to the material type of said flexible planar substrate used, whether polymer, paperboard, or metal). Said aperture forming support tabs are shown in FIG. 3,36 before forming, and in FIG. 4,36 after forming. In this present case of a planar polymer display substrate, said support tabs FIG. 3,36 are heat-formed, folded over a mold element of a close diameter as that diameter of said leg set, approximately 180 degrees and back onto, and adjacent to the rearward surface of the vertically lower area of said main body of display substrate, where surfaces contact each other FIG. 4,36, and a longitudinal and elongate leg aperture is formed with tolerances matching diameter of metal rod of said leg set and also matching the desired ability of said leg set to slide smoothly and elongately within said leg set aperture FIG. 4,18. The remaining portions of said aperture forming support tabs FIG. 4,36 will provide a greater vertical rigidity and a greater springable resistance to compression of said display substrate.

A (u-shape) leg set FIG. 4,14 is formed from a metal wire rod, with a slight bend formed near each elongate end FIG. 4,16. One leg of said leg set is positioned parallel to the vertically lower and rearward planar surface of said display and adjacent to said aperture forming support tab. Said tab is then lifted away from said rearward planar surface of display substrate to allow a horizontal sliding of one individual leg behind said tab until leg is positioned into said leg set aperture FIG. 4,18. A slight bend FIG. 4,16 at the elongate end of both leg tips prevents said leg set from prematurely and longitudinally exiting said leg set aperture.

FIG. 4 shows present state of completion, with said display substrate in a relaxed tension free mode for handling and storage.

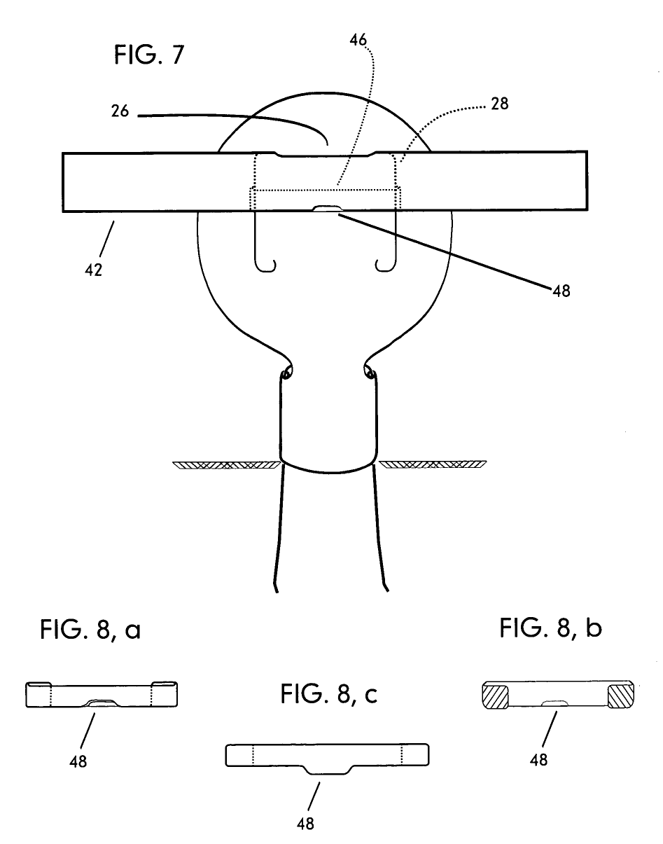

FIG. 8,a and FIG. 8,b show resulting tab after the last process of fabrication; the heat bending of said vertically adjustable sliding clip. FIG. 8,c shows polymer substrate shape before bends are made. Each elongate end FIG. 8,c is heat formed and folded approximately 180 degrees around side edges and toward rearward surface of said indicia retaining appendage for a slidably but snug fit. The center positioned tab at vertically lower edge FIG. 8,c,48 is then bent toward user, frontwardly, upwardly, and bent approximately 180 degrees from original position; creating a retaining and recessed area for retaining the vertically lower edge of rigid indicia substrate, as the vertically upper edge of said substrate is positioned and retained under and behind the rigid indicia retaining tab FIG. 7,26.

FIG. 7 shows the present state of completion with said rigid indicia 42 in position.

Various drawings showing different views, uses, and stages of fabrication are as follows;

Shown in FIG. 4,32 is a dotted line for visual width comparison between FIG. 4,32 and FIG. 1,32. FIG. 1 is a rear view showing both legs of said leg set positioned within said leg set apertures, whereas said display is under circumferencial compression and retension. FIG. 2 is an overhead view of FIG. 1. Shown are elongate bent leg tips 16; wire rod leg set 14; curvature of frontward convex surface of said display 34; and said leg set apertures 18.

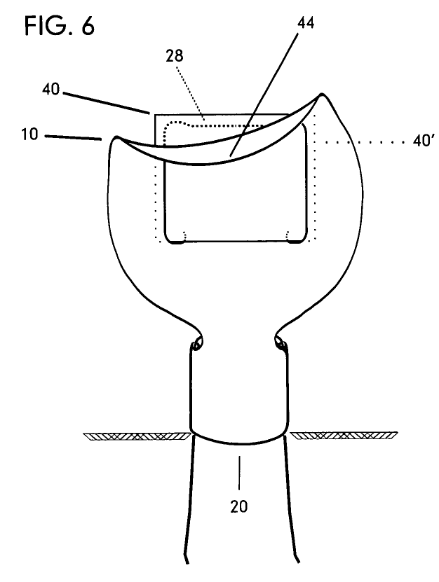

FIG. 6 is a front view of FIG. 1 with said flexible indicia substrate FIG. 6,40 inserted between said display substrate 10, and indicia retaining appendage 28, as the uppermost vertical planar edge 44 is pulled back toward user for easier insertion of said flexible indicia substrate 40. Frontward and slightly angled view of said curvature shape 20 is shown at vertically lower base area of said display substrate. Small dotted lines represent unseen areas of said indicia retaining appendage 28 (as per this specific view), as hidden by said flexible indicia substrate 40. Large dotted lines represent unseen areas of said flexible indicia substrate 40, as hidden by said main body of display substrate 10. Outer perimeter dimension of said flexible substrate is always larger than the dimension of said completely cut-through slit 24, or slit-formed said indicia retaining appendage 28. A rigid indicia substrate FIG. 7,42 is shown inserted into said display in FIG. 7. Said rigid indicia substrate 42 is positioned under and behind rigid indicia retaining tab 26, where said vertically adjustable sliding clip 46 is raised vertically upward until curved tab of said clip 48 rests under and supports said rigid indicia substrate. Dotted lines of said sliding clip 46 represent unseen area of said sliding clip, as hidden by said rigid indicia substrate 42. Dotted lines of FIG. 7,28 show hidden area of said indicia retaining appendage. A said flexible indicia substrate may be inserted and viewed simultaneously with a said rigid indicia substrate, with only a loss of viewing area equal to the amount which said rigid indicia substrate covers up. Said vertically adjustable sliding clip is shown in FIG. 8,a as a front view showing curved tab of said clip 48; and also in FIG. 8,b as a rear view, also showing curved tab of said clip 48. Said sliding clip is a separate and optional part, yet vertically retained onto and surrounding said indicia retaining appendage through the same tensions of compression and retention that hold said flexible indicia substrate.

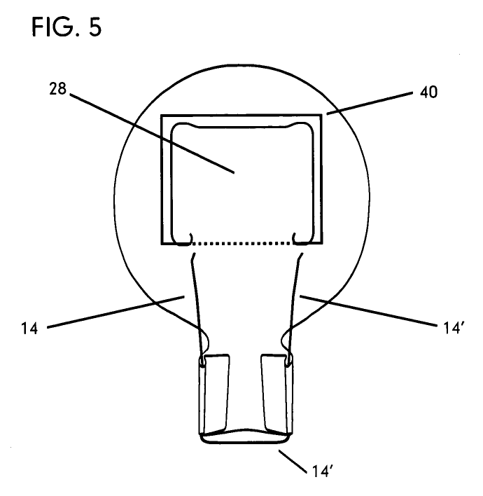

A counter-top, table-top, or free and self-standing floor display become options by removing said leg set (one leg at a time) and vertically inverting said leg set FIG. 5,14, then again replacing legs under each said aperture forming tab. The overall tensions are slightly and minutely reduced with said leg set in this inverted position, yet keeping more than needed for functional use as an indoor free-standing 3-D display.

Operation

Note that the vector line slit stressed endpoints of said aperture and appendage forming completely through cut slit, are shown in FIG. 1,22; and how their last positions and direction of travel are not directionally parallel with any 3 sides of perimeter of said formed appendage. These directionally predetermined end points will prevent further tearing or extending of said vector line slit; under normal and intended use, and when said display is subjected to directionally intended compression, curvature, and retension. Said appendage is not intended to be used as a handle to pull sign out of ground by, or be carried by, or to twist when inserting or removing any indicia substrates.

A display with one leg positioned within one aperture is in a relaxed state with all tensions released. This “flattened” for compact storage and stackable carrying mode is changed as the user lifts the other remaining support tab back and away from the rearward surface of display; and horizontally slides remaining leg under said tab until it is “snapped” positioned into place within the remaining leg set aperture. As this process is done, beginning stresses and tensions have already been placed on entire said display, including said leg set; which is then slid downwardly; pointedly away from user's body; and longitudinally and elongately within open areas of said leg set apertures. The full extension of said leg set completes compression, curvature shape, and then retains all stresses. User then pushes said extended leg set into ground with hands or foot. After user addresses the now upright display from frontward indicia viewing side, the uppermost planar perimeter edge FIG. 6,44 is pulled frontward and toward user's body to allow insertion of said flexible printed indicia, and then released. Said curvature shape causes said upper edge to “snap” position itself back to said state of tensioned curvature; wherein said indicia FIG. 6,40 is held tightly in place between said rearward concave surface of said display and frontward convex surface of said indicia substrate retaining appendage.

A rigid indicia substrate may be inserted at this time, as user again addresses said display from said frontward viewing side, then grips said edge 44 and pushes it rearward and away from user's body. This action lifts the rigid indicia retaining tab FIG. 7,26 for easy insertion of said rigid indicia substrate. The vertically upper planar edge is positioned under and behind said tab, with rearward surface of said rigid indicia substrate adjacent to frontward surface of said indicia substrate. Said vertically adjustable sliding clip FIG. 7,46 is then adjusted vertically until the indentation of its curved tab 48 contacts and supports the vertically lower planar edge of said rigid substrate 42. Said clip is optionally pre-mounted onto and partially surrounding said retainer appendage FIG. 7,28; and is retained by dimensionally close tolerances between said appendage and said main body of display, and retained tensions when in a state of compression. When said clip is not in use, there is no obstruction or interference with said indicia substrate when said clip is positioned at the vertically lowest position possible.

Other means for retention of said curvature shape can be used in addition to said leg set; including the current wire stands now widely in use; a fixed length plastic tie strap; an elastic bungee cord; and any fixed width abutments are all functional for retension.

User has the option at any time to remove said leg set, vertically invert, and replace said inverted leg set for multi-purpose indoor and outdoor uses FIG. 5.

We claim:

1: A cylindrically curved self supporting changeable indicia substrate retaining display comprising;
a completely through cut slit within the perimeter edge of a flexible planar substrate;
whereas the vector line path of said slit forms an indicia substrate retaining appendage;
and whereas said appendage is less in overall planar edge perimeter dimension than that of planar edge perimeter dimension of the indicia substrate to be inserted;
and whereas said indicia substrate is sandwiched between rearward and concave surface of said display and frontward and convex surface of said appendage;
and wherein said indicia substrate is secured by surrounding, opposing, and retained curvature stresses when said display substrate is subjected to resulting stresses of directionally predetermined circumferencial compression, curvature and retention of said compression;
and whereas said flexible display substrate acquires a more rigid and self supporting structure when subjected to said compression and curvature form;
and a means for said retension of said compression;
whereby a single said slit within said perimeter edge of a curvedly stressed flexible display substrate forms a cooperatively receiving aperture and appendage for securing and sandwiching a said indicia substrate opposingly to rearward and concave surface of said display substrate.

2: A substrate retaining display as claimed in claim 1, further comprising;
a completely through cut slit with directionally predetermined longitudinal vector line path beginning and ending points;
whereas said beginning and ending point approximated positions and direction of travel are not directionally parallel with any 3 sides of perimeter of said formed appendage;
whereby further longitudinal extending of said vector line path beginning and ending points is prevented when subjected to said directionally predetermined compression, curvature and retention of said flexible display substrate.

3: A substrate retaining display as claimed in claim 1, further comprising;
A fixed width wire rod leg set as a means for retention;
whereas the elongate end tips of legs of said leg set are slightly bent to prevent unintended exiting from elongate retaining apertures;
whereas said leg set remains slidably positionable within one, or a plurality of said elongate leg set retaining apertures;
whereas said apertures are formed from flexible tabular appendages;
whereas said appendages provide an exit and entry means for said leg set;
whereby said leg set is removable, vertically invertable, longitudinally extendable and retractable, and replaceable for changing said display from an indoor self supporting display to an outdoor and ground penetrating display.

4: A substrate retaining display as claimed in claim 1, further comprising;
a functional tab created by said vector line path of said slit.

5: A substrate retaining display as claimed in claim 1, further comprising;
A sliding retainer clip mounted onto, and partially surrounding indicia substrate retaining appendage;
whereas said sliding retainer clip is adjusted vertically upward until a curvedly shaped and frontwardly protruding tab of said sliding retainer clip contacts and supports the vertically lower planar edge of a rigid indicia substrate;
whereas the vertically upward planar edge of said rigid indicia substrate is secured under and behind a predeterminedly positioned rigid indicia substrate retaining tab formed in said display substrate;
whereas said sliding clip is secured by surrounding, opposing, and retained compression and curvature stresses surrounding said indicia retainer slit;
whereby said clip serves as a vertically adjustable retainer for said rigid indicia substrates of variable dimensional sizes and thicknesses.

6: A substrate retaining display as claimed in claim 1, further comprising;
a plurality of apertures in said display substrate for securing said means for retension.

7: A substrate retaining display as claimed in claim 1, further comprising;
a plurality of notches located at planar perimeter edge of said display substrate for securing said means for retension.

8: A substrate retaining display as claimed in claim 1, further comprising;
a said means for retention using separate and predeterminedly spaced abutments.

9: A substrate retaining display as claimed in claim 1, further comprising;
a said means for retention using an elongate elastically resilient material.

10: A substrate retaining display as claimed in claim 1, further comprising;
a said means for retention using an elongate non-elastic material.

11: A substrate retaining display as claimed in claim 1, further comprising;
a said means for retention using a fixed shape wire rod sign stake.

12: A substrate retaining display as claimed in claim 1, further comprising;
a said means for retention using predeterminedly spaced and cooperatively interconnecting tabs and notches formed at or near the perimeter edge of said display substrate.
